(19) United States
(12) Patent Application Publication
(10) Pub. No.: US 2014/0248808 A1
(43) Pub. Date: Sep. 4, 2014

(54) METHOD FOR PRODUCING A SCREW CONNECTION TERMINAL

(71) Applicant: PHOENIX CONTACT GMBH & CO. KG, Blomberg (DE)

(72) Inventor: Wilfried Niehoerster, Steinheim (DE)

(21) Appl. No.: 14/350,090

(22) PCT Filed: Oct. 11, 2012
(86) PCT No.: PCT/EP2012/004260

§ 371 Date: Apr. 7, 2014

(30) Foreign Application Priority Data
Oct. 12, 2011 (DE) 10 2011 054 417.8

(51) Int. Cl. H01R 43/00; H01R 4/36

(52) U.S. Cl. CPC H01R 43/00; H01R 4/36
USPC 439/810; 29/874

(57) ABSTRACT

A method for producing a screw connection terminal includes providing a flat metal. The method includes forming a conductor insertion opening into a longitudinal lateral surface of the flat metal. The method includes driving apart the material of the flat metal so as to introduce an eyelet opening into an end face surface of the flat metal. A diameter of the eyelet opening is larger than a thickness of the flat metal in a region of the conductor insertion opening. The method also includes introducing a thread into the eyelet opening.

### CROSS-REFERENCE TO RELATED APPLICATIONS

This application is a U.S. National Phase application under 35 U.S.C. §371 of International Application No. PCT/EP2012/004260, filed on Oct. 11, 2012, and claims benefit to German Patent Application No. DE 10 2011 054 417.8, filed on Oct. 12, 2011. The International Application was published in German on Apr. 18, 2013 as WO 2013/053477 A1 under PCT Article 21 (2).

### FIELD

The invention relates to a method for producing a screw connection terminal. The invention also relates to a screw connection terminal and a connection arrangement comprising such a screw connection terminal and a busbar.

### BACKGROUND

Screw connection terminals serve to establish an electrical connection between at least two conductors, by either clamping the conductors together in the conductor insertion opening constructed in the screw connection terminal thus connecting them to each other electrically or by connecting the conductors indirectly to each other via an electrically conductive contact body, for example, a busbar, one of the conductors being fixed in the conductor insertion opening of the screw connection terminal and the other conductor being contacted by means of an additional electrical contact element. Such screw connection terminals can be used in modular terminal blocks for quite different contact and connection purposes. Modular terminal blocks can be used, for example, in plant construction and can be provided in a switch cabinet for top hat rail assembly, two screw connection terminals being connected to each other, for example, using a busbar. Such modular terminal blocks, which can be used for assembly on printed circuit boards, for example, can be used in circuit technology. Due to the usually only very restricted available space in such switch cabinets, there is a consistent demand for such screw connection terminals to be constructed such that they are as compact as possible with reduced outer dimensions, without reducing the potential clamping force of the screw connection terminal to be applied in the process.

### SUMMARY

In an embodiment, the present invention provides a method for producing a screw connection terminal comprising providing a flat metal. The method includes forming a conductor insertion opening into a longitudinal lateral surface of the flat metal. The method includes driving apart the material of the flat metal so as to introduce an eyelet opening into an end face surface of the flat metal. A diameter of the eyelet opening is larger than a thickness of the flat metal in a region of the conductor insertion opening. The method also includes introducing a thread into the eyelet opening.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a schematic view of a flow diagram of a method for producing a screw connection terminal out of a flat metal according to an embodiment of the invention,

FIG. 2 shows a schematic view of a screw connection terminal according to the invention produced according to a method shown in FIG. 1 in a side view,

FIG. 3 shows a perspective view of a connection arrangement with a screw connection terminal according to the invention produced according to a method shown in FIG. 1,

FIG. 4 shows a schematic view of a flow diagram of a method for producing a screw connection terminal from a round wire according to an embodiment of the invention,

FIG. 5 shows a schematic view of a screw connection terminal according to the invention produced according to a method shown in FIG. 4 in a side view,

FIG. 6 shows a perspective view of a connection arrangement with a screw connection terminal according to the invention produced according to the method shown in FIG. 4,

FIG. 7 shows a schematic view of a support arm of a screw connection terminal with a contour according to an embodiment of the invention,

FIG. 8 shows a schematic view of a busbar of a connection arrangement with an indent according to an embodiment of the invention,

FIG. 9 shows a schematic view of a flat metal for forming a screw connection terminal with a folded thread region according to the invention,

FIG. 10 shows a schematic view of a screw connection terminal according to the invention with a folded thread region produced from a flat metal as shown in FIG. 9 in a plan view onto a longitudinal lateral surface of the screw connection terminal,

FIG. 11 shows a schematic view of a screw connection terminal according to the invention with a folded thread region produced from a flat metal as shown in FIG. 9 in a plan view onto a transverse lateral surface of the screw connection terminal,

FIG. 12 shows a schematic view of a screw connection terminal according to the invention with a folded thread region produced from a flat metal as shown in FIG. 9 in a plan view onto an end face surface of the screw connection terminal, and

FIG. 13 shows a schematic view of a connection arrangement according to the invention with a busbar and two screw connection terminals formed as one part integrally on the busbar.

### DETAILED DESCRIPTION

An aspect of the invention provides a system in which the dimensions of a screw connection terminal, in particular in relation to its overall depth, and therefore also the dimensions of a connection arrangement, can be reduced.

In an embodiment, the invention includes providing a flat metal, introducing a conductor insertion opening in the form of a through-opening into a longitudinal lateral surface of the flat metal, introducing an eyelet opening into an end face surface of the flat metal by driving apart the material of the flat metal such that the diameter of the eyelet opening is larger than the thickness of the flat metal in the region of the conductor insertion opening, and introducing a thread into the eyelet opening.

In another embodiment, the invention includes providing a round wire, dividing the round wire into a thread region and a conductor insertion region, the conductor insertion region being deformed plastically into a substantially plate-shaped form, introducing a conductor insertion opening in the form of a through-opening into a longitudinal lateral surface of the plastically deformed conductor insertion region, introducing an eyelet opening into the thread region of the round wire such that the diameter of the eyelet opening is larger than the thickness of the plate-shaped conductor insertion region, and introducing a thread into the eyelet opening.

According to some embodiments of the invention, it is possible to produce a screw connection terminal with reduced dimensions, in particular reduced overall depth, which can be installed in a particularly space-saving manner, for example in a switch cabinet, such that this can be used conveniently especially where only limited installation space is available. In the process, the invention provides for the screw connection terminal to be produced from a flat metal or a round wire. The flat metal already has a very thin thickness and depth compared to its width in its initial state so that by forming a screw connection terminal out of such a flat metal the overall depth of the screw connection terminal compared to conventional screw connection terminals can be substantially reduced. In the case of a screw connection terminal produced from a round wire, the original diameter of the round wire can be substantially reduced by plastically deforming it apart from the region where the threaded eyelet is formed, such that it receives a plate-shaped form with a very low thickness or depth compared to its width, such that when forming a screw connection terminal from such a round wire also, the overall depth of the screw connection terminal can be substantially reduced compared to conventional screw connection terminals.

When producing the screw connection terminal from a flat metal, a conductor insertion opening is first introduced into a longitudinal lateral surface of the flat metal in the form of a through-opening, for example by stamping. Furthermore, an eyelet opening is introduced into an end face surface of the flat metal by driving apart the material of the flat metal. When driving the material apart, the material of the flat metal is forced outwards in this region such that a material through-passage or material eyelet is formed here in the form of a through-opening, which is bordered by the material that has been driven apart and the edge of the through-opening is formed by the material that has been driven apart. The material can be driven apart, for example, by means of an awl, which is struck into the end face surface, or a drill. By driving the material apart, the outer circumference of the flat metal in this region of the later threaded eyelet enlarges such that the diameter of the eyelet opening becomes larger than the thickness of the flat metal in the region of the conductor insertion opening. After introducing the eyelet opening, a thread is introduced into the eyelet opening by forming or cutting by means of which a screw for clamping a conductor fed through the conductor insertion opening into the screw connection terminal can be screwed.

When producing the screw connection terminal from a round wire, which is formed from a copper alloy or steel, for example, the round wire is first divided into a thread region and a conductor insertion region. The outer dimensions of the thread region can substantially still correspond to the outer dimensions of the round wire even after the production of the screw connection terminal such that the thread region is already predefined by the round wire before the production of the screw connection terminal. During production of the round wire it is cold drawn, the grain boundaries of the material of the round wire already being aligned in the process such that a particularly high level of stability of the round wire is achieved. Since no reshaping of the round wire to form the thread region is necessary in this region, the high level of stability achieved by aligning the grain boundaries in the cold drawing process of the round wire can be used here. It is, however, also possible to deform the outer dimensions of the thread region during the production of the round wire. The outer dimensions of the conductor insertion region on the other hand are substantially changed during the production process of the screw connection terminal. Firstly, the conductor insertion region is plastically deformed in the process into a substantially plate-shaped form such that the conductor insertion region is flat. The plastic can be deformed, for example, by using a hammer. The conductor insertion region can be deformed such that the grain boundaries of the material of the round wire also remain aligned here such that the material continues to have a high level of stability, which is comparable to the stability of the cold-drawn round wire, as a result of which the load capacity of the later screw connection terminal is very high. Following the plastic deformation, a conductor insertion opening is introduced into a longitudinal lateral surface of the now flat conductor insertion region in the form of a through-opening. The through-opening can, for example, be introduced into the conductor insertion region by stamping. Following the introduction of the conductor insertion opening, or even before the introduction of the conductor insertion opening, an eyelet opening is introduced into the thread region of the round wire. The eyelet opening can be introduced by drilling an opening. Then a thread is introduced into the eyelet opening by means of deformation or cutting. Because the external shape of the thread region is not deformed during the production of the screw connection terminal in contrast to the conductor insertion region, the diameter of the eyelet opening is also larger than the thickness of the plate-shaped, flat conductor insertion region in the case of this method for producing a screw connection terminal out of a round wire.

In the case of the production of the screw connection terminal out of a flat metal, the end face surface of the flat metal can be formed by folding two lateral regions of the flat metal into one another before introducing the eyelet opening. The flat metal can be u-shaped here after the conductor insertion opening has been introduced, two opposite lateral regions each protruding outwardly being formed at the free ends of the u-shape. These outwardly protruding lateral regions can be bent inwards towards the conductor insertion opening in an additional step in the process such that they form the upper limit of the conductor insertion opening. In the process, the two lateral regions are folded into each other such that no additional means, such as welding, are necessary in order to connect the two lateral regions securely together in a tight fit without the risk that they could unfold again by themselves. The eyelet opening can be introduced into these lateral regions which have been folded into each other.

Furthermore, both in the case of the production of the screw connection terminal from a flat metal and in the case of the production of the screw connection terminal from a round wire, it can be provided for a contour for the formation of a spring region to be introduced into the support arms laterally bordering the conductor insertion opening. As a result of the formation of a spring region in the screw connection terminal by introducing a contour into the support arms it is possible to achieve a situation where no loosening of the contact point occurs due to a weakening of the clamp effect of the screw of the screw connection terminal as a consequence of the plastic deformation of a conductor clamped in the screw connection terminal. When the screw is tightened, an elastic deformation can occur in the region of the contour of the support arms, which can extend the loosening torque of the screw being screwed into the threaded eyelet, in that a kind of spring effect of the screw, which is screwed in and is clamping a conductor, is achieved. A contour can be formed in each of the two opposite support arms of a screw connection terminal.

According to an embodiment of the invention, this contour is s-shaped. Thus a particularly good spring effect can be achieved in the support arms. Alternatively, it is also possible, for example, for the contour to be z-shaped or zigzag-shaped.

In the case of a connection arrangement according to the invention, the busbar can have a substantially larger width than the width of the conductor insertion opening of the screw connection terminal, the busbar having two recesses, which are formed opposite each other in the region of the conductor insertion opening and in which the support arms laterally bordering the conductor insertion opening engage. Thus the busbar is retained in the screw connection terminal such that it cannot tilt or slip, whereby a particularly secure contact of a conductor with a busbar can be guaranteed.

It is also provided for the busbar to have an indent along its longitudinal surface for the defined reception of a screw of the screw connection terminal while a conductor is being clamped. Due to the indent, a defined contact point of the screw with the busbar and thus also the busbar with the conductor can be formed. The indent can be formed such that during the clamping of a conductor the screw exerts a force onto the busbar in the region of the indent. Due to the indent, a reduction of the torque to be applied by the screw and thus a reduction of the necessary screw size can be achieved, whereby the screw connection terminal and thus also the connection arrangement can be even more compact with reduced dimensions.

According to another advantageous embodiment of the invention, the screw connection terminal is connected to the busbar as one part. Due to a single-part construction of the screw connection terminal with a busbar, the whole connection arrangement can be produced in more compact form and thus with reduced component dimensions. Due to the more compact construction, the consumption of materials for the production of such a connection arrangement can be reduced in comparison to conventional connection arrangements, in which the screw connection terminal and the busbar are two parts formed separately from one another. A connection arrangement according to the invention can, for example, be stamped out of a flat metal and bent into a finished form, which constitutes the form that is used in the connection arrangement. Costly production processes are thus no longer needed for the production of a connection arrangement according to the invention, whereby the cost of production and also the manufacturing costs can be reduced in comparison to conventional connection arrangements.

According to an embodiment of the connection arrangement, it is provided for the screw terminal connection and the busbar to be constructed from the same material. By constructing the screw connection terminal and the busbar from one and the same material, the production costs and time and thus also manufacturing costs can be reduced further. The screw connection terminal and the busbar can be constructed of steel here.

Alternatively, it is also possible according to the invention for the screw connection terminal to be constructed of a different material than the busbar, the screw connection terminal can be constructed of steel and the busbar of aluminium. By using different materials for the screw connection terminal and the busbar, which can be constructed as one piece, for example by means of a plating process, the required properties of the screw connection terminal and the busbar can be selected separately by selecting a suitable material for each. If, for example, the screw connection terminal is constructed of steel, a particularly good mechanical strength can be achieved. If the busbar is constructed of aluminium, for example, the weight of the busbar and thus of the whole connection arrangement can be reduced. The selection of material is not limited to steel and aluminium here, but rather other materials can also be used.

The invention is described in more detail hereinafter with reference to embodiments and the accompanying drawings.

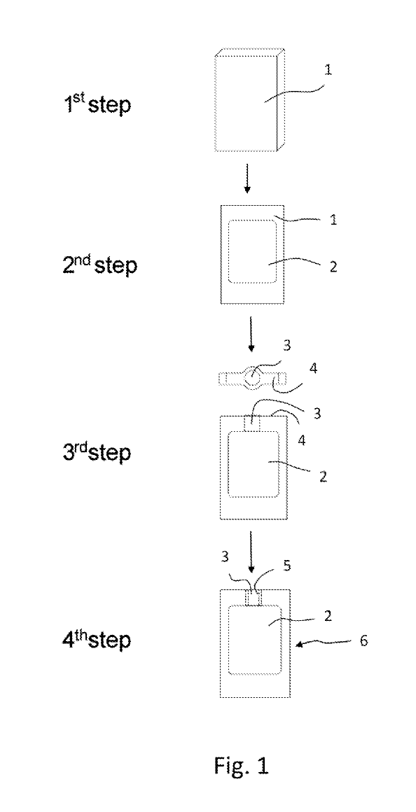

In FIG. 1 a flow diagram for producing a screw connection terminal out of a flat metal 1 is shown. In a first step, a flat metal 1 is provided. In a second step, a conductor insertion opening 2 is introduced in the form of a through-opening into a longitudinal lateral surface of the flat metal 1, for example by stamping. In a third step, an eyelet opening 3 is introduced into an end face surface 4 of the flat metal 1 by driving apart the material of the flat metal 1 such that the diameter of the eyelet opening 3 is larger than the thickness of the flat metal 1 in the region of the conductor insertion opening 2, as can be seen in the plan view onto the longitudinal lateral surface 4. Whilst the material is being driven apart, the material of the flat metal 1 in this region is forced outwards so that a material passage or material eyelet is formed here in the form of an eyelet opening 3, which is bordered by the material that has been driven apart and the edge of the eyelet opening 3 is formed by the material that has been driven apart. The material can be driven apart, for example, using an awl, which is struck into the flat metal 1 in the region of the longitudinal lateral surface 4, or a drill. Due to the material being driven apart, the outer circumference of the flat metal 1 enlarges in the region of the later threaded eyelet such that the diameter of the eyelet opening 3 becomes larger than the thickness of the flat metal 1 in the region of the conductor insertion opening 2. In a fourth and final step, a thread 5 is introduced into the eyelet opening 3 by forming or cutting, thus the threaded eyelet is formed via which a screw can be screwed. As soon as the thread 5 has been introduced, the screw connection terminal 6 is finished.

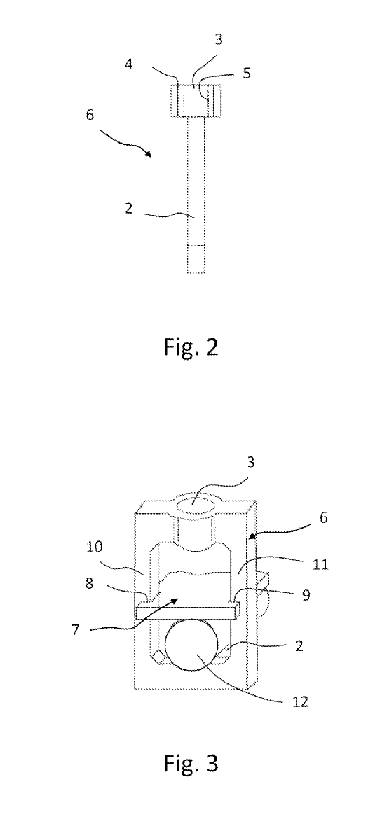

FIG. 2 shows a screw connection terminal 6, which is produced according to the method shown in FIG. 1 in a side view. It can be seen here that the screw connection terminal 6 is formed such that it is substantially wider in the region of the eyelet opening 3 of the threaded eyelet than in the region of the conductor insertion opening 2.

FIG. 3 shows a connection arrangement with a screw connection terminal 6 as shown in FIGS. 1 and 2 and with a busbar 7. The busbar 7 has a substantially larger width than the conductor insertion opening 2 of the screw connection terminal 6, the busbar having two recesses 8, 9 which are formed opposite each other in the region of the conductor insertion opening 2 and into which the support arms 10, 11 of the screw connection terminal 6 bordering the conductor insertion opening 2 engage. This can prevent the busbar 7 from tilting or slipping inside the conductor insertion opening 2 of the screw connection terminal 6. A conductor 12 to be clamped is retained by clamping between an edge region of the conductor insertion opening 2 and the busbar 7 by means of a screw.

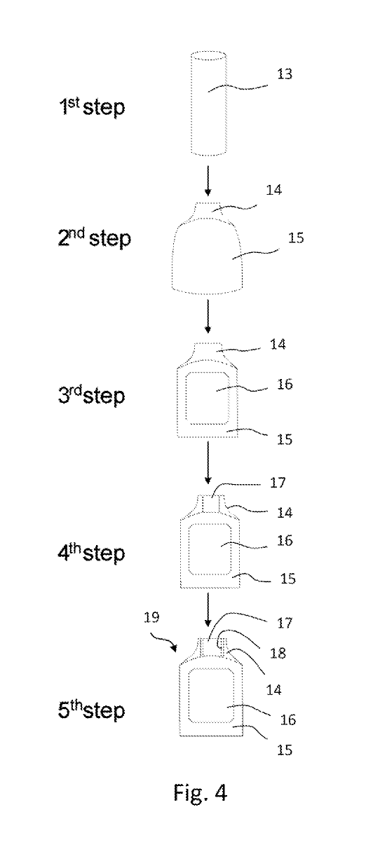

In FIG. 4, a flow diagram for producing a screw connection terminal out of a round wire 13 is shown. In a first step, a round wire 13 is provided. In a second step, the round wire 13 is divided into a thread region 14 and a conductor insertion region 15, the conductor insertion region 15 being plastically deformed, for example, by means of hammering, into a substantially plate-shaped form, such that the conductor insertion region 15 is flat in contrast to the thread region. The thread region 14, in some embodiments, is not deformed in the region of its outer surface so that its outer surface can continue to correspond to the outer surface of the round wire 13. In a third step, a conductor insertion opening 16 in the form of a through-opening is introduced into a longitudinal lateral surface of the plastically deformed conductor insertion region 15, for example, by stamping. Then in a fourth step, an eyelet opening 17 is introduced into the thread region 14 of the round wire 1 such that the diameter of the eyelet opening 17 is larger than the thickness of the plate-shaped conductor insertion region 16. Finally, in a fifth step, a thread 18 is introduced into the eyelet opening 17 by forming or cutting. As soon as the thread 18 has been introduced, the screw connection terminal 19 is finished.

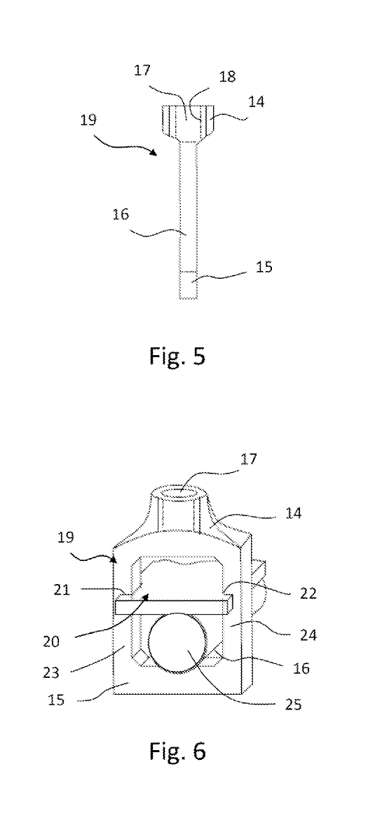

FIG. 5 shows a screw connection terminal 19, which is produced according to the method shown in FIG. 1, in a side view. It can be seen here that the screw connection terminal 19 is formed such that it is substantially wider in the region of the eyelet opening 17 of the threaded eyelet than in the region of the conductor insertion opening 16.

FIG. 6 shows a connection arrangement with a screw connection terminal 19 as shown in FIGS. 4 and 5 and with a busbar 20. The busbar 20 has a substantially larger width than the width of the conductor insertion opening 16 of the screw connection terminal 19, the busbar 20 having two recesses 21, 22, which are formed opposite each other in the region of the conductor insertion opening 16, and into which the support arms 23, 24 of the screw connection terminal 19 bordering the conductor insertion opening 16 engage. This can prevent a tilting or slipping of the busbar 20 inside the conductor insertion opening 16 of the screw connection terminal 19. A conductor 25, which is to be clamped, is held in a clamped manner between an edge region of the conductor insertion opening 2 and the busbar 7 using a screw.

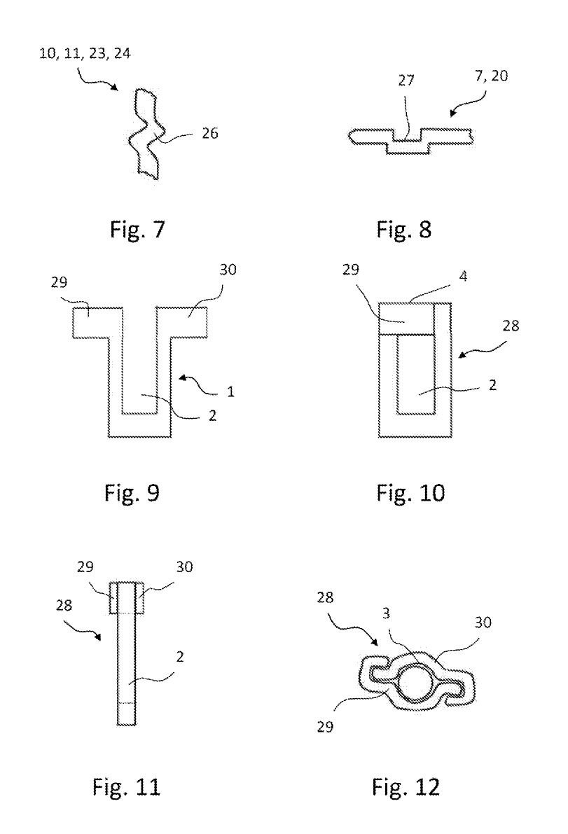

FIG. 7 shows a segment of a support arm, 10, 11, 23, 24 of a screw connection terminal 6, 19, the support arm 10, 11, 23, 24 having a special contour 26 in order to form a spring region and thus achieve a spring action of the support arms 10, 11, 23, 24. The contour shown here is in the form of bending, in particular an s-shaped, z-shaped or zigzag bending.

FIG. 8 shows a segment of a busbar 7, 20, the busbar 7, 20 having an indent 27 for the defined receiving of a screw of the screw connection terminal 6, 19 whilst a conductor 12, 25 is clamped. The indent 27 is constructed in the form of a step or indentation in the busbar 7, 20. When a conductor 12, 25 is clamped, the end of the shaft of the screw is inserted into the indent 27 of the busbar 7, 20 and presses against the busbar 7, 20 in the region of the indent 27 such that a defined contact point is formed.

FIGS. 9-12 show another possible embodiment of a screw connection terminal 28 according to the invention, which is produced from a flat metal 1. The flat metal 1 is u-shaped after the conductor insertion opening 2 has been introduced, as can be seen if FIG. 9, two opposite lateral regions each protruding outwardly being formed at the free ends of the u-shape. These outwardly protruding lateral regions 29, 30 can be bent inwards towards the conductor insertion opening 2 in an additional step in the process, such that they form the upper limit of the conductor insertion opening 2 and thus the end face surface 4 of the flat metal 1, as can be seen in FIG. 10. In the process, the two lateral regions 29, 30 are folded into each other, as can be seen in FIGS. 11 and 12, such that no additional costly process steps, such as for example welding, are necessary in order to be able to connect the two lateral regions 29, 30 securely together in a tight fit without the risk that they could unfold again. The eyelet opening 3 and a thread can be introduced into these lateral regions 29, 30, which have been folded into each other. In FIG. 11, such a screw connection terminal 28 with a folded thread region is shown in a plan view onto the transverse lateral surface of the screw connection terminal 28. In FIG. 12, such a screw connection terminal 28 with a folded thread region is shown in a plan view onto the end face surface 4 of the screw connection terminal 28.

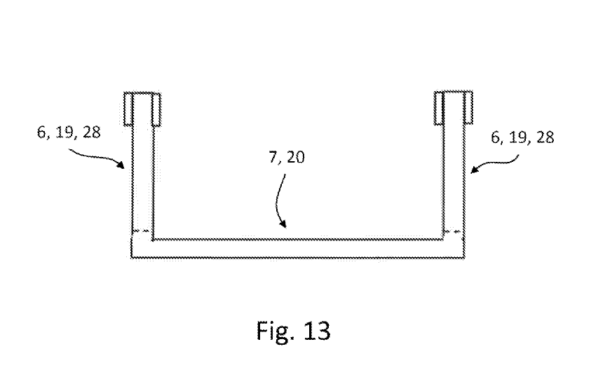

Furthermore, in FIG. 13 another possible embodiment of a connection arrangement according to the invention with two screw connection terminals 6, 19, 28 and a busbar 7, 20 is shown, the screw connection terminals 6, 19, 28 being formed of one part integrally on each respective end portion of the busbar 7, 20.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

Flat metal 1
Conductor insertion opening 2
Eyelet opening 3
End face surface 4
Thread 5
Screw connection terminal 6
Busbar 7
Recess 8
Recess 9
Support arm 10
Support arm 11
Conductor 12
Round wire 13
Thread region 14
Conductor insertion region 15
Conductor insertion opening 16
Eyelet opening 17
Thread 18
Screw connection terminal 9
Busbar 20
Recess 21
Recess 22
Support arm 23
Support arm 24
Conductor 25
Contour 26
Indent 27
Screw connection terminal 28
Lateral region 29
Lateral region 30

1-12. (canceled)

13. A method for producing a screw connection terminal, the method comprising:
providing a flat metal;
forming a conductor insertion opening into a longitudinal lateral surface of the flat metal;
driving apart the material of the flat metal so as to introduce an eyelet opening into an end face surface of the flat metal such that a diameter of the eyelet opening is larger than a thickness of the flat metal in a region of the conductor insertion opening; and
introducing a thread into the eyelet opening.

14. The method as recited in claim 13 further comprising forming the end face surface by folding two lateral regions of the flat metal into each other before introducing the eyelet opening into the end face surface.

15. The method as recited in claim 13, wherein support arms laterally border the conductor insertion opening, the method further comprising forming a contour into the support arms to form a spring region.

16. The method as recited in claim 15, wherein the contour is s-shaped.

17. A method for producing a screw connection terminal, the method comprising:
providing a round wire;
dividing the round wire into a thread region and a conductor insertion region, the conductor insertion region being plastically deformed so as to be substantially plate-shaped;
forming a conductor insertion opening in a longitudinal lateral surface of the conductor insertion region;
forming an eyelet opening into the thread region of the round wire such that a diameter of the eyelet opening is larger than a thickness of the conductor insertion region; and
introducing a thread into the eyelet opening.

18. The method as recited in claim 17, wherein support arms laterally border the conductor insertion opening, the method further comprising forming a contour into the support arms to form a spring region.

19. The method as recited in claim 18, wherein the contour is s-shaped.

20. A screw connection terminal produced according to the method of claim 13.

21. The screw connection terminal as recited in claim 20, wherein support arms laterally border the conductor insertion opening.

22. The screw connection terminal as recited in claim 21, wherein the support arms include a contour to form a spring region.

23. The screw connection terminal as recited in claim 22, wherein the contour is s-shaped.

24. A screw connection terminal produced according to the method of claim 17.

25. A connection arrangement comprising:
a screw connection terminal produced according to the method of claim 13; and
a busbar.

26. The connection arrangement of claim 25, further comprising:
support arms laterally bordering the conductor insertion opening; and
a busbar having a larger width than a width of the conductor insertion opening and having two recesses formed opposite each other, the busbar disposed in the conductor insertion opening such that the two recesses engage with the support arms of the screw connection terminal

27. The connection arrangement as recited in claim 24, wherein the busbar further comprises an indent along a longitudinal surface, the indented adapted to receive a screw while a conductor is clamped.

28. The connection arrangement as recited in claim 24, wherein the screw connection terminal is connected as one part to the busbar.

29. The connection arrangement as recited in claim 26, wherein the screw connection terminal and the busbar are formed of the same material.

30. The connection arrangement as recited in claim 26, wherein the screw connection terminal is made from a different material than the busbar, the screw connection terminal being constructed of steel and the busbar being constructed of aluminum.

31. A connection arrangement comprising:
a screw connection terminal produced according to the method of claim 17; and
a busbar.

32. The connection arrangement of claim 31, further comprising:
support arms laterally bordering the conductor insertion opening; and
a busbar having a larger width than a width of the conductor insertion opening and having two recesses formed opposite each other, the busbar disposed in the conductor insertion opening such that the two recesses engage with the support arms of the screw connection terminal.
